(19) United States
(12) Patent Application Publication
(10) Pub. No.: US 2017/0211591 A1
(43) Pub. Date: Jul. 27, 2017

(54) Impeller having a Solidified Ultraviolet-Curing Adhesive, Fan having the Impeller, Impeller Weight-Balancing Method, and Impeller Weight-Balancing Adjustment System

(71) Applicant: Sunonwealth Electric Machine Industry Co., Ltd., Kaohsiung City (TW)

(72) Inventors: Alex Horng, Kaohsiung City (TW); Tso-Kuo Yin, Kaohsiung City (TW); Wei-Chieh Chao, Kaohsiung City (TW)

(21) Appl. No.: 15/391,939

(22) Filed: Dec. 28, 2016

(30) Foreign Application Priority Data
Jan. 26, 2016 (TW) 105102354
Jul. 28, 2016 (TW) 105123940

(51) Int. Cl. F04D 29/66; B29C 65/14; B29C 65/48

(52) U.S. Cl. CPC F04D 29/662; B29C 65/4805; B29C 65/1406; B29L 2031/08

(57) ABSTRACT

An impeller having a solidified ultraviolet-curing adhesive, a fan having the impeller, and an impeller weight-balancing method are provided to solve the problems of the conventional impeller weight-balancing method as the conventional method can only be used with the impeller having high production complexity and manufacturing cost and has a low operational efficiency and a low weight-balancing precision. In addition to the solidified ultraviolet-curing adhesive, the impeller further includes a shaft, a hub and an air-driving unit. The hub is coupled with the shaft. The air-driving unit is coupled with the hub. The solidified ultraviolet-curing adhesive is coupled with a surface of the air-driving unit.

### CROSS REFERENCE TO RELATED APPLICATIONS

The application claims the benefit of Taiwan application serial Nos. 105102354 and 105123940, respectively filed on Jan. 26, 2016 and Jul. 28, 2016, and the subject matters of which are incorporated herein by reference.

### BACKGROUND OF THE INVENTION

1. Field of the Invention

The present disclosure generally relates to an impeller, a fan having the impeller, an impeller weight-balancing method, and an impeller weight-balancing adjustment system and, more particularly, to an impeller weight-balancing method that uses a solidified ultraviolet-curing adhesive to balance the weight of an impeller, an impeller having the solidified ultraviolet-curing adhesive for balancing the weight thereof, and a fan having the impeller.

2. Description of the Related Art

During the operation of a rotating device (such as a fan or an engine), if the rotation is imbalanced, a self-excited force may be generated which leads to some negative effects such as vibration, noise or malfunction. As an example of a fan, when an impeller rotates, the rotation of the impeller would become imbalanced if the impeller operates in an improper environment temperature, has a certain manufacturing tolerance, an asymmetric structure or uneven material distribution, or is deformed or improperly assembled. To avoid the above disadvantages, the fan as a finished product needs to undergo a calibration process to balance its rotation.

FIG. 1 shows an impeller used in a conventional impeller weight-balancing method. In general, an impeller 9 is placed on a rotation calibration machine. The impeller 9 is rotated by the rotation calibration machine to find out the possible location(s) of the impeller 9 which causes the imbalanced rotation. Then, the impeller 9 is retrieved from the machine, and one or more weights 91 are added to or removed from said location(s) of the impeller 9, such as the blades or the hub. This process is to adjust the center of mass of the fan in order for the center of mass to approach the rotation axis of the fan. The above calibration process is repeated until the rotation of the rotor is balanced.

The fan requires the blades or the hub of the impeller 9 to form the holes 92 for receiving the weight(s) 91. However, forming the holes 92 on the impeller 9 increases the structural complexity of the impeller 9, leading to inconvenient production process and high cost. Furthermore, since the weight(s) 91 must be securely fixed in the hole(s) 92 to prevent the weight(s) 91 from disengaging from the hole(s) 92 during the rotation of the impeller 9, the installation or removal of the weight(s) 91 is time-consuming, leading to a low weight-balancing efficiency of the impeller.

Since the locations of the hole(s) 92 are fixed, if it is calculated that some weights 91 need to be added to certain locations of the impeller 9 but the impeller 9 does not form the holes 92 on said locations, the weight of the impeller 9 cannot be balanced. Moreover, since the size of the weight 91 is fixed, the weight of the weight 91 is also fixed. In this regard, if the required weight is calculated to be larger or smaller than the actual weight of the weight 91, the weight of the impeller 9 also cannot be balanced. Thus, the conventional impeller weight-balancing method cannot precisely balance the weight of the impeller 9, making it difficult to achieve a balanced rotation of the impeller 9.

Furthermore, the modern fan usually has a thin design in order to be used in a small-size electronic device such as a hand-held electronic device. Therefore, the impeller is usually lightweight. However, the lightweight impeller cannot form the holes 92 due to high manufacturing complexity and limited manufacturing cost. As a result, the conventional impeller weight-balancing method is not applicable to a thin impeller.

In summary, the conventional impeller weight-balancing method not only has a limited applicability (only suitable for the impeller with high production complexity and manufacturing cost), low operational efficiency, and low precision in balancing the weight of the impeller, but also cannot be used in a thin impeller. Thus, many disadvantages and limitations raise during the use of the conventional impeller weight-balancing method, making it necessary to improve the conventional impeller weight-balancing method.

### SUMMARY OF THE INVENTION

It is therefore the objective of this disclosure to provide an impeller weight-balancing method which uses an adhesive injector to inject an amount of an ultraviolet-curing adhesive having a balancing weight to a weighting location of the impeller, and uses an ultraviolet light source to irradiate ultraviolet light on the ultraviolet-curing adhesive to solidify said adhesive as a solidified ultraviolet-curing adhesive.

It is another objective of this disclosure to provide an impeller having a solidified ultraviolet-curing adhesive, and a fan having the impeller. In the structure of the impeller, a solidified ultraviolet-curing adhesive is arranged on the surface of an air-driving unit to adjust the center of mass of the impeller back on the shaft of the impeller.

It is a further objective of this disclosure to provide an impeller weight-balancing adjustment system, which includes a balance detection module, an electrical control module, a compensating module and a solidification module to perform the impeller weight-balancing method, thus forming the impeller having the solidified ultraviolet-curing adhesive.

In an embodiment of the disclosure, an impeller including a solidified ultraviolet-curing adhesive for weight-balancing purpose is disclosed. The impeller includes a shaft, a hub, an air-driving unit and the solidified ultraviolet-curing adhesive. The hub is coupled with the shaft. The air-driving unit is coupled with the hub. The solidified ultraviolet-curing adhesive is coupled with a surface of the air-driving unit.

The solidified ultraviolet-curing adhesive is obtained from an ultraviolet-curing adhesive which is solidified as the solidified ultraviolet-curing adhesive under irradiation of the ultraviolet light. As such, the ultraviolet-curing adhesive can be rapidly solidified as the solidified ultraviolet-curing adhesive under the irradiation of the ultraviolet light, reducing the time that is needed to fix the solidified ultraviolet-curing adhesive to the impeller.

In a form shown, the air-driving unit includes a plurality of blades respectively extending in a plurality of radial directions of the shaft. Each of the plurality of blades includes a radially outward edge at a side radially away from the shaft, and the solidified ultraviolet-curing adhesive is relatively adjacent to the radially outward edge and relatively distant to the shaft. This reduces the balancing weight that is needed to balance the impeller.

In another form shown, the air-driving unit includes a plurality of blades respectively extending in a plurality of radial directions of the shaft. Each of the plurality of blades includes a radially outward edge at a side radially away from the shaft, and the solidified ultraviolet-curing adhesive is arranged on the radially outward edge of one of the plurality of blades. This reduces the balancing weight that is needed to balance the impeller.

The radially outward edges of the plurality of blades form an outer circumference in a circumferential direction perpendicular to the shaft, and a radial distance between the outer circumference and the solidified ultraviolet-curing adhesive is smaller than another radial distance between the solidified ultraviolet-curing adhesive and the shaft. This reduces the balancing weight that is needed to balance the impeller.

The air-driving unit includes a plurality of blades coupled with an outer periphery of the hub, and the solidified ultraviolet-curing adhesive is coupled with one of the plurality of blades. As such, the impeller may be used in an axial fan or an advection-type fan, and the solidified ultraviolet-curing adhesive can be arranged on any part of the blade. As such, the location of the solidified ultraviolet-curing adhesive is not limited.

Each of the plurality of blades includes a lower face and an upper face opposite to the lower face. The lower face is located at an air outlet side of the impeller, and the upper face is located at an air inlet side of the impeller. The solidified ultraviolet-curing adhesive is arranged on the lower face of one of the plurality of blades. As such, the user will not easily notice the solidified ultraviolet-curing adhesive from the air outlet side of the impeller, maintaining an appearance integrity of the impeller. Alternatively, the solidified ultraviolet-curing adhesive can be arranged on the upper face of one of the plurality of blades, permitting the solidified ultraviolet-curing adhesive to be arranged on the blade more conveniently.

The air-driving unit includes a bottom plate coupled with an outer periphery of the hub, as well as a plurality of blades coupled with the bottom plate. The solidified ultraviolet-curing adhesive is coupled with one of the plurality of blades. As such, the impeller may be used in an axial fan or an advection-type fan, and the solidified ultraviolet-curing adhesive can be arranged on any part of the blade. As such, the location of the solidified ultraviolet-curing adhesive is not limited.

The air-driving unit includes a bottom plate coupled with an outer periphery of the hub, as well as a plurality of blades coupled with the bottom plate. The solidified ultraviolet-curing adhesive is coupled with the bottom plate. As such, the bottom plate can be used for arrangement of the solidified ultraviolet-curing adhesive, therefore the location of the solidified ultraviolet-curing adhesive is not limited.

The air-driving unit includes a plurality of blades, a bottom plate and a noise-reducing ring. The bottom plate is coupled with an outer periphery of the hub. The bottom plate and the noise-reducing ring are coupled with the plurality of blades and respectively located at two sides of the plurality of blades in an axle direction of the shaft. The solidified ultraviolet-curing adhesive is coupled with the noise-reducing ring. As such, the noise-reducing ring can be used for arrangement of the solidified ultraviolet-curing adhesive, therefore the location of the solidified ultraviolet-curing adhesive is not limited.

The noise-reducing ring includes an upper face and a lower face opposite to the upper face. The upper face faces away from the bottom plate, the lower face faces the bottom plate, and the solidified ultraviolet-curing adhesive is arranged on the upper face of the noise-reducing ring. As such, the upper face of the noise-reducing ring is in an uncovered state, enabling the adhesive injector to inject the ultraviolet-curing adhesive to the upper face of the noise-reducing ring. Also, the ultraviolet light of the ultraviolet light source can easily reach the ultraviolet-curing adhesive, facilitating the solidification process of the ultraviolet-curing adhesive. As such, the processing of the impeller is convenient.

The noise-reducing ring includes an upper face and a lower face opposite to the upper face. The upper face faces away from the bottom plate, the lower face faces the bottom plate, and the solidified ultraviolet-curing adhesive is arranged on the lower face of the noise-reducing ring. As such, since the lower face of the noise-reducing ring faces the bottom plate, the user will not easily notice the solidified ultraviolet-curing adhesive from the air outlet side or the air inlet side of the impeller, maintaining the appearance integrity of the impeller.

The hub and the air-driving unit have a height in an axle direction of the shaft, and the height is equal to or smaller than 6 mm. As such, the solidified ultraviolet-curing adhesive having the balancing weight can be fixed to the weighting location of the impeller to adjust the center of mass of the impeller back on the shaft while permitting the impeller to be used in a thin fan.

In another embodiment, a fan having the impeller provided with the solidified ultraviolet-curing adhesive for weight-balancing purpose is disclosed. The fan further includes a stator to which the shaft is rotatably coupled. As such, the solidified ultraviolet-curing adhesive having the balancing weight can be fixed to the weighting location of the impeller to adjust the center of mass of the impeller back on the shaft, enabling the impeller to rotate stably relative to the stator with reduced vibration and noise.

The hub and the air-driving unit have a height in an axle direction of the shaft, and the height is equal to or smaller than 6 mm. As such, the fan can have a thin design.

In a further embodiment, an impeller weight-balancing method is disclosed. The impeller weight-balancing method includes receiving information regarding a weighting location and a balancing weight of an impeller by a compensating module, injecting an amount of an ultraviolet-curing adhesive, which has the balancing weight, to the weighting location of the impeller by an adhesive injector of the compensating module, and irradiating ultraviolet light on the ultraviolet-curing adhesive by an ultraviolet light source of a solidification module. The ultraviolet-curing adhesive is solidified and fixed to the weighting location of the impeller under irradiation of the ultraviolet light.

The adhesive injector has a minimal injection amount being 0.04 mg, and the adhesive injector is capable of injecting the amount of the ultraviolet-curing adhesive to the weighting location of the impeller if the balancing weight is larger than or equal to 0.04 mg. As such, the

The step of irradiating the ultraviolet light includes irradiating the ultraviolet light on the ultraviolet-curing adhesive for 3-5 seconds. As such, the ultraviolet-curing adhesive can solidify as the solidified ultraviolet-curing adhesive in 3-5 seconds under irradiation of the ultraviolet light, thus advantageously reducing the time required to fix the solidified ultraviolet-curing adhesive to the impeller.

The adhesive injector is in a form of a dropper, and injecting the ultraviolet-curing adhesive includes dripping the amount of the ultraviolet-curing adhesive to the weighting location of the impeller in an injection direction by the dropper. As such, the ultraviolet-curing adhesive can be arranged via the use of the dropper.

The adhesive injector is in a form of a nozzle, and injecting the ultraviolet-curing adhesive includes spraying the amount of the ultraviolet-curing adhesive to the weighting location of the impeller in an injection direction by the nozzle. As such, the ultraviolet-curing adhesive can be arranged via the control of the nozzle.

The impeller weight-balancing method further includes moving the impeller with an aligning member of the compensating module. As such, the adhesive injector can face the weighting location without having to move.

The impeller weight-balancing method further includes calculating whether the impeller needs to be balanced according to an offset, as performed by an electrical control module. If the impeller needs to be balanced, the impeller weight-balancing method further includes setting the weighting location and the balancing weight of the impeller according to the offset, as performed by the electrical control module. As such, among a plurality of impellers, the electrical control module sets the weighting location and the balancing weight only for the impeller which requires a balance in weight, improving the operational efficiency of the impeller weight-balancing method.

The impeller weight-balancing method further includes detecting the offset of the impeller with a balance detection module and outputting information regarding the offset of the impeller to the electrical control module prior to the calculation of the electrical control module. As such, the electrical control module is able to receive the offset information from the balance detection module, thus accordingly setting the weighting location and the balancing weight of the impeller.

In the impeller weight-balancing method, detecting the offset of the impeller includes driving the impeller to rotate using a motor of the balance detection module. When the center of mass of the impeller is not on the shaft, the impeller will rotate in an imbalanced manner and start to shake. In this regard, an offset detection unit can be used to detect the shaking magnitude of the impeller when the motor drives the impeller to rotate. The shaking magnitude of the impeller includes information regarding a face run-out and a shaft run-out.

In the impeller weight-balancing method, the balance detection module uses an offset detection unit to detect the information regarding a face run-out and a shaft run-out. Accordingly, the offset of the impeller can be generated. As such, the offset detection unit can detect the shaking magnitude of the impeller in order for the balance detection module to calculate the offset of the center of mass of the impeller.

In the impeller weight-balancing method, detecting the offset of the impeller includes arranging a reference mark on a surface of the impeller, moving the impeller to the balance detection module by a delivery unit, and aligning the reference mark with a positioning portion of the balance detection module by the delivery unit. As such, the reference mark can be used as a reference for the balance detection module to determine the location of the impeller.

In the impeller weight-balancing method, if the electrical control module determines that the impeller needs to be balanced, the impeller weight-balancing method further includes moving the impeller to the compensating module by the delivery unit, and aligning the reference mark with a positioning portion of the compensating module by the delivery unit. As such, the balance detection module and the compensating module can have the same reference in determining the location of the impeller, ensuring the compensating module to properly locate the weighting location.

In still a further embodiment, an impeller weight-balancing adjustment system is disclosed. The impeller weight-balancing adjustment system includes a balance detection module, an electrical control module, a compensating module and a solidification module. The balance detection module is capable of detecting an offset of an impeller. The electrical control module is coupled with the balance detection module and receives information regarding the offset of the impeller from the balance detection module. The electrical control module sets a weighting location and a balancing weight of the impeller according to the received information. The compensating module receives information regarding the weighting location and the balancing weight and includes an adhesive injector. The compensating module is capable of injecting an amount of an ultraviolet-curing adhesive, which has the balancing weight, to the weighting location of the impeller via the adhesive injector. The solidification module includes an ultraviolet light source and is coupled with the electrical control module or the compensating module. The solidification module is capable of irradiating ultraviolet light on the ultraviolet-curing adhesive with the ultraviolet light source.

The compensating module includes an aligning member which moves the impeller so that the weighting location of the impeller is aligned with the adhesive injector after the compensating module receives the information regarding the weighting location. As such, the adhesive injector can face the weighting location without having to move.

The balance detection module includes a motor adapted to drive the impeller to rotate, so as to detect the offset of the impeller. When the center of mass of the impeller is not on the shaft, the impeller will rotate in an imbalanced manner and start to shake. In this regard, an offset detection unit can be used to detect the shaking magnitude of the impeller when the motor drives the impeller to rotate. The shaking magnitude of the impeller includes information regarding a face run-out and a shaft run-out.

The balance detection module includes an offset detection unit capable of detecting information regarding a face run-out and a shaft run-out, so as to detect the offset of the impeller. As such, the offset detection unit can detect the shaking magnitude of the impeller in order for the balance detection module to calculate the offset of the center of mass of the impeller.

The impeller weight-balancing adjustment system further includes a delivery unit coupled with the electrical control module and capable of moving the impeller to the balance detection module or the compensating module. As such, before the balance detection module detects the offset, a reference mark can be arranged on the surface of the impeller. Then, the delivery unit can move the impeller to the balance detection module and the compensating module, and align the reference mark with the positioning portion of the balance detection module or the compensating module. This permits the balance detection module and the compensating module to have the same reference in determining the location of the impeller, ensuring the compensating module to properly locate the weighting location.

The delivery unit includes a visual positioning member capable of locating the impeller. As such, the electrical control module can use the delivery unit to move the impeller, and to align the reference mark of the impeller with the positioning portion of the balance detection module or the compensating module.

With the impeller having the solidified ultraviolet-curing adhesive, the fan having the impeller, the impeller weight-balancing method, and the impeller weight-balancing adjustment system as proposed in various embodiments of the disclosure, the solidified ultraviolet-curing adhesive can be arranged on the weighting location of the impeller to adjust the center of mass of the impeller back on the shaft. Therefore, the impeller does not need to form any hole for weight-balancing purpose, nor does it need to undergo any other pretreatment. Advantageously, the impeller can have a lower structural complexity and can be used in a thin fan with a reduced height. Accordingly, the difficulty encountered in the production process and the manufacturing cost can be reduced, and the applicability of the impeller weight-balancing method can be improved. Furthermore, the ultraviolet-curing adhesive can quickly solidify as the solidified ultraviolet-curing adhesive under irradiation of the ultraviolet light, thus reducing the time that is needed to fix the solidified ultraviolet-curing adhesive to the impeller. As such, the efficiency in balancing the weight of the impeller can be improved. Besides, the weight and location of the solidified ultraviolet-curing adhesive are not limited, increasing the precision in balancing the weight of the impeller.

### BRIEF DESCRIPTION OF THE DRAWINGS

The present disclosure will become more fully understood from the detailed description given hereinafter and the accompanying drawings which are given by way of illustration only, and thus are not limitative of the present disclosure, and wherein:

FIG. 1 is a partial view of an impeller used in a conventional impeller weight-balancing method.

FIG. 2 shows a block diagram of an impeller weight-balancing adjustment system according to the disclosure.

FIG. 3 shows an impeller having possible weighting locations and possible balancing weights calculated by an impeller weight-balancing method according to an embodiment of the disclosure.

FIG. 4 shows a diagram in which the impeller weight-balancing method according to the embodiment of the disclosure injects an UV-curing adhesive to an impeller.

FIG. 5 shows a diagram in which the impeller weight-balancing method according to the embodiment of the disclosure irradiates ultraviolet light on the UV-curing adhesive.

FIG. 6 shows the impeller having a solidified UV-curing adhesive.

FIG. 7 is a partial view of a fan mounted with the impeller having the solidified UV-curing adhesive.

FIG. 8 shows an impeller in which a solidified UV-curing adhesive is arranged on a radially outward edge of one of the blades of the impeller.

FIG. 9 is a side view of the impeller shown in FIG. 8.

FIG. 10 shows an impeller (used in a centrifugal fan) having a bottom plate provided with a solidified UV-curing adhesive.

FIG. 11 shows an impeller (used in a centrifugal fan) having a noise-reducing ring in which a solidified UV-curing adhesive is arranged on an upper face of the noise-reducing ring.

FIG. 12 shows the impeller of FIG. 11 but the solidified UV-curing adhesive is arranged on a lower face of the noise-reducing ring.

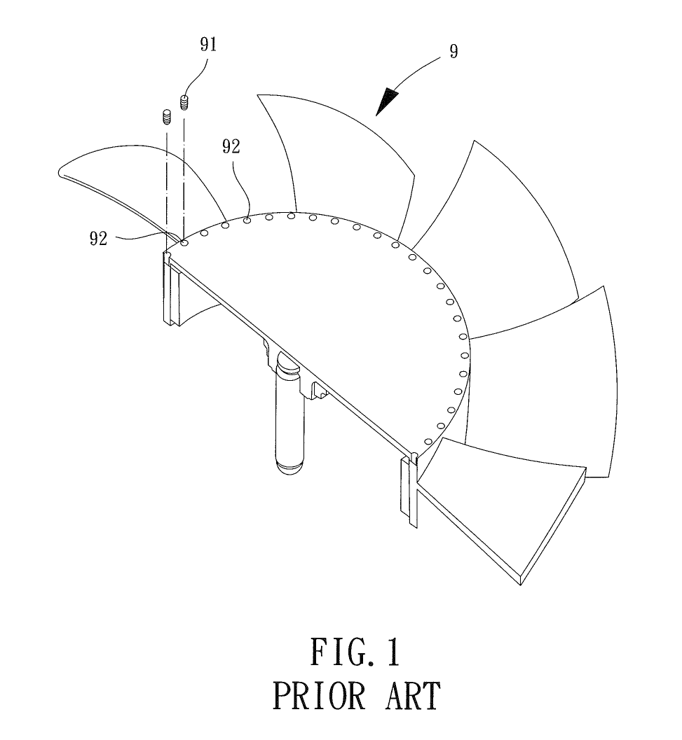

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the disclosure.

### DETAILED DESCRIPTION OF THE INVENTION

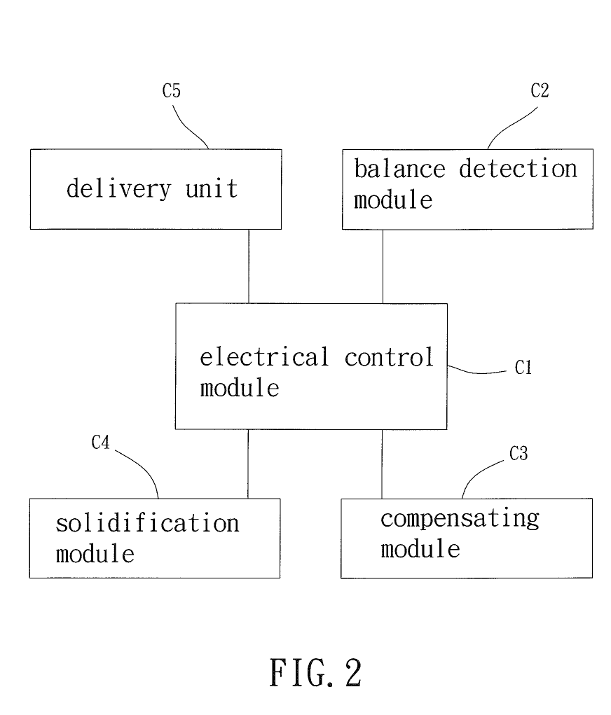

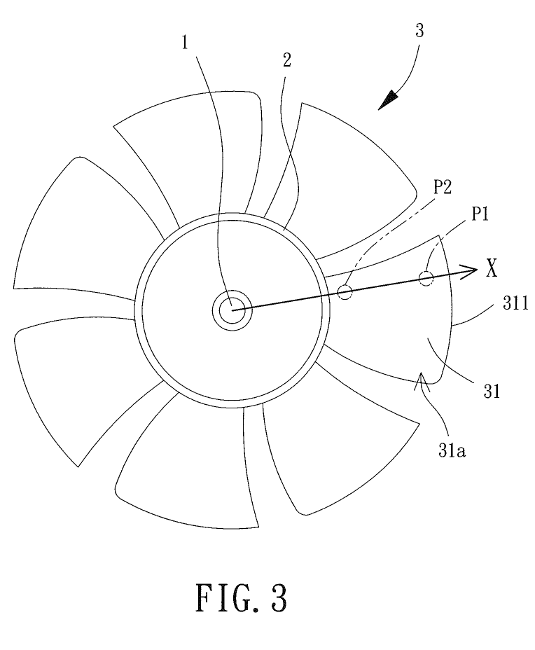

Referring to FIG. 2, in an embodiment of an impeller weight-balancing method of the disclosure, an impeller weight-balancing adjustment system can be used to balance the weight of the impeller. The impeller weight-balancing adjustment system includes an electrical control module C1, a balance detection module C2, a compensating module C3 and a solidification module C4. The electrical control module C1 is electrically coupled to the balance detection module C2, the compensating module C3 and the solidification module C4. The electrical control module C1 can be any device with calculation function, such as a host computer, a workstation or a microcontroller unit. In addition, the electrical control module C1 can set a weighting location (the location where a weight is to be placed) and a balancing weight (how much weight that needs to be added to or removed from the weighting location) of an impeller. Referring to FIG. 3, the impeller includes a shaft 1, a hub 2 and an air-driving unit 3. The hub 2 is coupled with the shaft 1, and the air-driving unit 3 is coupled with the hub 2.

Specifically, the electrical control module C1 determines whether the weight of the impeller needs to be balanced according to an offset. If the determined result is positive, the electrical control module C1 sets the weighting location and the balancing weight of the impeller, and stores the information regarding the weighting location and the balancing weight in a memory device. The electrical control module C1 can also output the information regarding the weighting location and the balancing weight to an external display or a storage unit. If the determined result is negative, the electrical control module C1 may not set the weighting location and the balancing weight of the impeller, or simply sets the states of the weighting location and the balancing weight as being invalid such as “null” or “0.” As such, for the impeller that requires a balance in weight, the electrical control module C1 simply needs to set the weighting location and the balancing weight of the impeller. In this approach, the efficiency of the impeller weight-balancing method of the disclosure can be improved.

The offset is generated by the balance detection module C2. The balance detection module C2 may include devices such as a motor, an offset detection unit and a processor. When the impeller is moved to the balance detection module C2, the motor will drive the impeller to rotate. If the center of mass of the impeller is not on the shaft 1, the impeller will rotate in an imbalanced manner and start to shake. The offset detection unit is an electronic element that can detect the magnitude of the movement of an object, such as a G-sensor, an optical rangefinder or a camera. This permits the offset detection unit to detect the shaking magnitude of the impeller. The shaking magnitude at least includes the information regarding the face run-out and the shaft run-out. Based on this, the processor is able to calculate the offset of the center of mass of the impeller. Then, the balance detection module C2 checks and outputs the offset of the center of mass of the impeller to the electrical control module C1, so that the electrical control module C1 is able to calculate the weighting location and the balancing weight that are required to adjust the impeller back to the proper position where the rotation of the impeller is balanced.

Since the motor itself may generate vibration during the rotation thereof, the impeller weight-balancing method according to the embodiment of the disclosure may use the offset detection unit to detect the shaking magnitude of the motor in advance, and store the detected magnitude in the balance detection module C2. Thus, after the shaking magnitude of the impeller is obtained by the offset detection unit, the shaking magnitude of the motor can be deducted from the shaking magnitude of the impeller to obtain the information that is used to balance the weight of the impeller.

One having ordinary skill in the art would readily appreciate that the impeller has multiple weighting locations and balancing weights that are required to adjust the center of mass of the impeller back on the shaft 1. For example, in a radial direction X of the shaft 1, the impeller may have a first weighting location P1 and a second weighting location P2. In this regard, if the center of mass of the impeller can be adjusted back on the shaft 1 by adding only a first balancing weight W1 on the first weighting location P1, it is known that the center of mass of the impeller can also be adjusted back on the shaft 1 by adding only a second balancing weight W2 on the second weighting location P2. However, since the distance between the first weighting location P1 and the shaft 1 is larger than that between the second weighting location P2 and the shaft 1, the second balancing weight W2 needs to be larger than the first balancing weight W1. Since the air-driving unit 3 is radially outward of the hub 2, the electrical control module C1 can set the weighting location(s) on the air-driving unit 3 in order to reduce the weight that needs to be added to the impeller.

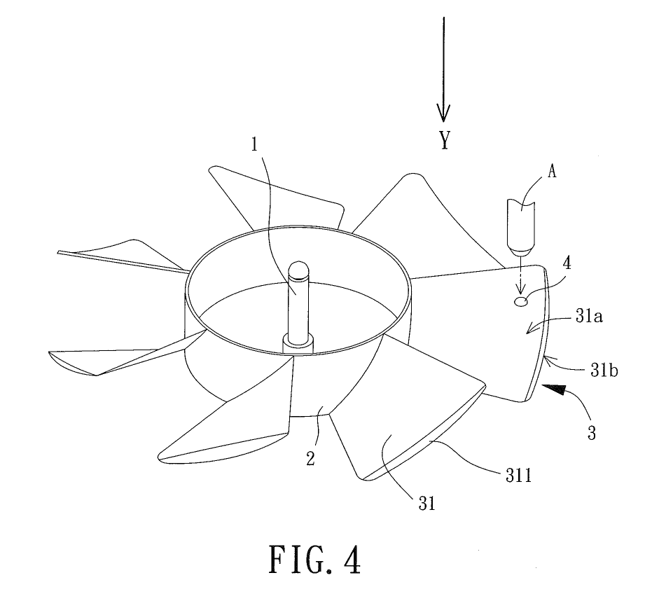

Referring to FIG. 4, the compensating module C3 includes an adhesive injector A. When the impeller is moved to the compensating module C3, the compensating module C3 will receive the information regarding the weighting location(s) and balancing weight(s). Based on this, the adhesive injector A will inject an amount of an ultraviolet-curing (UV-curing) adhesive, which has the balancing weight, to the weighting location of the air-driving unit 3. In the embodiment, since the compensating module C3 is coupled to the electrical control module C1, the electrical control module C1 can store the information regarding the weighting location(s) and balancing weight(s) in a memory device. Thus, the electrical control module C1 is able to output said information to the compensating module C3. However, the electrical control module C1 can also output said information to an external display or a storage unit, permitting said information to be input to the compensating module C3 from other devices or in a manual manner. Therefore, in another embodiment of the disclosure, the compensating module C3 does not need to be coupled to the electrical control module C1. The disclosure is not limited to either option. The adhesive injector A can be in the form of a dropper. As such, the UV-curing adhesive 4 can be manually dripped to the weighting location of the impeller in an injection direction Y. However, the adhesive injector A may also be in the form of a nozzle, permitting the UV-curing adhesive 4 to be sprayed to the weighting location of the impeller in an injection direction Y as controlled by an automatic machine. The injection direction Y is parallel to the shaft 1, so that the UV-curing adhesive 4 can be uniformly distributed on the weighting location of the impeller. However, this is not used to limit the disclosure.

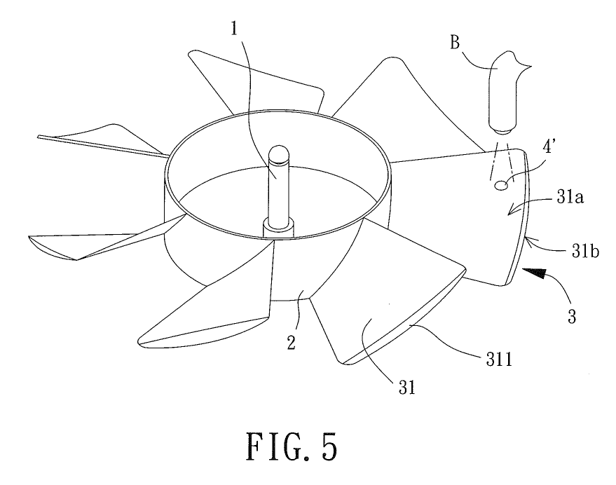

Referring to FIG. 5, the solidification module C4 includes an ultraviolet light source B that irradiates ultraviolet light on the UV-curing adhesive 4. As such, the UV-curing adhesive 4 will solidify under the irradiation of the ultraviolet light. The UV-curing adhesive 4 will solidify as a solidified UV-curing adhesive 4′ that remains in place on the weighting location of the impeller. Generally, the UV-curing adhesive 4 solidifies as the solidified UV-curing adhesive 4′ in 3-5 seconds under the irradiation of the ultraviolet light. Thus, the ultraviolet light source B may irradiate ultraviolet light on the UV-curing adhesive 4 for 3-5 seconds. Therefore, the solidified UV-curing adhesive 4′ having the balancing weight can be fixed to the weighting location of the impeller after the operation of the impeller weight-balancing method of the disclosure. This can adjust the center of mass of the impeller back on the shaft 1, forming the solidified UV-curing adhesive on the impeller for weight-balancing purpose. In the embodiment, the compensating module C3 is coupled with the electrical control module C1, therefore the solidification module C4 is also coupled with the electrical control module C1. As such, the electrical control module C1 can integrally control the operations of the compensating module C3 and the solidification module C4. However, in another embodiment of the impeller weight-balancing adjustment system, the compensating module C3 does not need to be electrically coupled to the electrical control module C1. In such a manner, the solidification module C4 can be directly coupled to the compensating module C3, such that the compensating module C3 and the solidification module C4 can cooperate with each other.

It is noted that the compensating module C3 preferably includes an aligning member that can move the impeller. After the compensating module C3 receives the information regarding the weighting location(s) and the balancing weight(s), the impeller is moved by the aligning member in order to align the weighting location with the adhesive injector A. In this regard, the adhesive injector A can face the weighting location without having to move. Then, the UV-curing adhesive 4 is distributed to the weighting location. The adhesive injector A can be raised and lowered to shorten the distance between the adhesive injector A and the weighting location, thus smoothly distributing the UV-curing adhesive 4 on the weighting location. Similarly, the compensating module C3 can move the impeller via the aligning member in order to align the weighting location with the ultraviolet light source B of the solidification module C4. Thus, the ultraviolet light source B can irradiate ultraviolet light on the UV-curing adhesive 4 without having to move. However, in another embodiment, the solidification module C4 can move the ultraviolet light source B to align the ultraviolet light source B with the weighting location, permitting the ultraviolet light source B to irradiate ultraviolet light on the UV-curing adhesive 4. As such, the solidification module C4 can irradiate the ultraviolet light on the impellers of multiple compensating modules C3, improving the efficiency of the solidification module C4.

Besides, in order for the compensating module C3 to locate the weighting location, the electrical control module C1 can be further coupled with a delivery unit C5. The delivery unit C5 may be a clamping claw, a robotic arm or a conveyor. In this regard, both the balance detection module C2 and the compensating module C3 can include a positioning portion. The positioning portion may be any indicator capable of providing a reference for positioning purposes, such as a scale, a mark, or a laser beam. In this arrangement, before the balance detection module C2 detects the offset, a reference mark such as a reference line can be arranged on the surface of the impeller. Then, the delivery unit C5 can move the impeller to the balance detection module C2 so that the reference mark is aligned with the positioning portion of the balance detection module C2. If the electrical control module C1 determines that the impeller needs to be balanced, the electrical control module C1 simply controls the delivery unit C5 to move the impeller to the compensating module C3 so that the reference mark is aligned with the positioning portion of the compensating module C3. As such, the balance detection module C2 and the compensating module C3 can have the same reference in determining the location of the impeller, ensuring the compensating module C3 to properly locate the weighting location.

In the above, the delivery unit C5 may include a visual positioning member which can perform functions such as image reception, image identification and distance detection. These functions enable the delivery unit C5 to locate the impeller by receiving the image of the impeller, identifying the impeller and its reference mark, and detecting the distance between the impeller and the delivery unit C5. Based on the above, the electrical control module C1 can use the delivery unit C5 to move the impeller to a position where the reference mark of the impeller is aligned with the positioning portion of the balance detection module C2 or the compensating module C3.

The impeller having the solidified UV-curing adhesive can be mounted in a fan. The fan may include a stator with which the shaft 1 is rotatably coupled. As such, the stator can drive the impeller to rotate, enabling the rotating air-driving unit 3 to generate air currents. Since the center of mass of the impeller can be adjusted back on the shaft 1 via the use of the solidified UV-curing adhesive 4′, the impeller can rotate stably relative to the stator with reduced vibration and noise.

Although the impeller having the solidified UV-curing adhesive 4′ often needs to be rotated due to repeated balance tests, performance verification, or practical use in a fan, the solidified UV-curing adhesive 4′ will not displace under the centrifugal force generated by the rotation of the impeller as the UV-curing adhesive 4 has already solidified as said adhesive 4′. This ensures the solidified UV-curing adhesive 4′ to be securely fixed to the weighting location of the impeller.

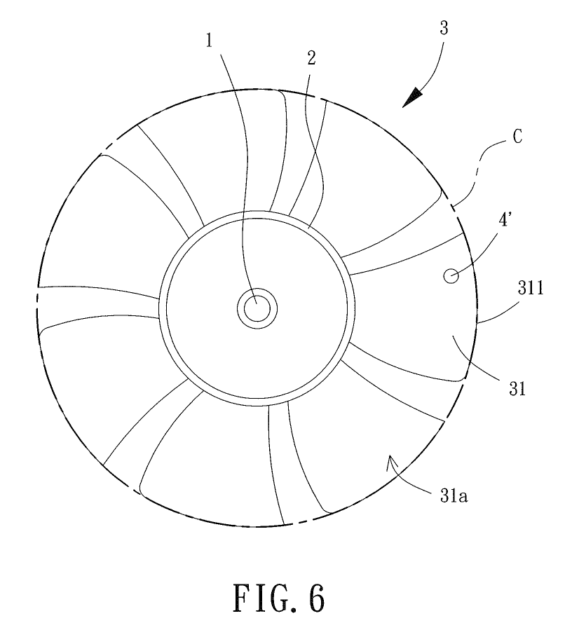

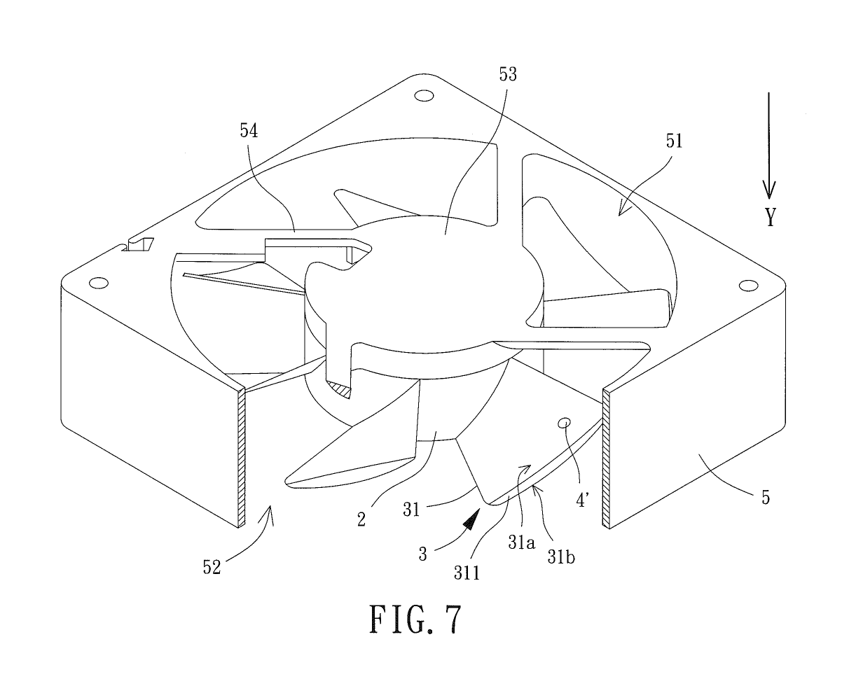

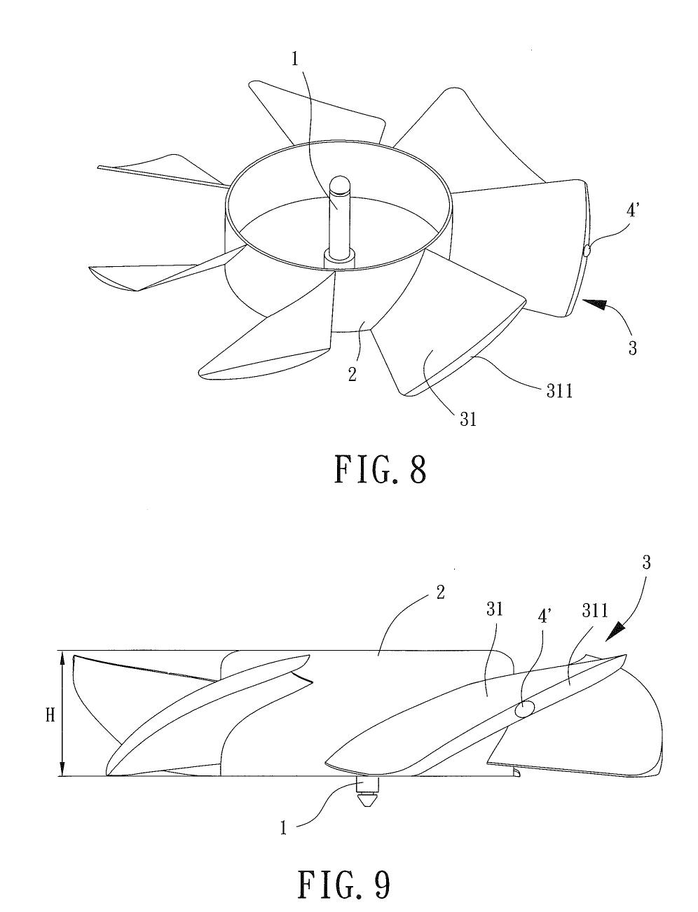

Referring to FIGS. 6 and 7, the air-driving unit 3 includes a plurality of blades 31 extending in the radial directions of the shaft 1. Each blade 31 includes a radially outward edge 311 at a side radially away from the shaft 1. When the solidified UV-curing adhesive 4′ is coupled to the surface of the air-driving unit 3, said adhesive 4′ is adjacent to the radially outward edge 311 and distant to the shaft 1. Alternatively, referring to FIG. 8 showing another embodiment of the disclosure, the solidified UV-curing adhesive 4′ can directly couple with the radially outward edge 311 of the blade 31. Specifically, the radially outward edges 311 of all the blades 31 can form an outer circumference C in a circumferential direction perpendicular to the shaft 1. The radial distance between the outer circumference C and the solidified UV-curing adhesive 4′ is smaller than that between the solidified UV-curing adhesive 4′ and the shaft 1. This can reduce the balancing weight that is needed to be added to the impeller.

Referring to FIG. 7, in the embodiment, the impeller may be used in an axial fan. Therefore, the blades 31 of the air-driving unit 3 are coupled with the outer periphery of the hub 2 while the solidified UV-curing adhesive 4′ is arranged on one of the blades 31. Based on this, the solidified UV-curing adhesive 4′ can be fixed to any location of the blade 31. Advantageously, the location of the solidified UV-curing adhesive 4′ is not limited. Besides, each blade 31 may include a lower face 31a and an upper face 31b opposite to the lower face 31a. The lower face 31a is the face of the impeller located at an air outlet side of the impeller, and the upper face 31b is the face of the impeller located at an air inlet side of the impeller. The solidified UV-curing adhesive 4′ can be arranged on the lower face 31a. When the impeller is mounted in a fan, the stator of the fan may couple with a fan frame 5 having an air outlet 51 and an air inlet 52 at two sides thereof. In this arrangement, since the lower face 31a is located at the air outlet side of the impeller, the lower face 31a will face the air outlet 51 of the fan frame 5. The fan frame 5 usually includes a base 53 at the air outlet 51, and the shaft 1 of the impeller can couple with the base 53. Furthermore, the base 53 usually includes a plurality of ribs 54 extending through the air outlet 51. The base 53 together with the ribs 54 can cover the lower faces 31a of the blades 31, therefore the user will not easily be aware of the presence of the solidified UV-curing adhesive 4′ from the air outlet side of the impeller. This can ensure an appearance integrity of the processed impeller (i.e. the impeller having the solidified UV-curing adhesive). Alternatively, the solidified UV-curing adhesive 4′ can be arranged on the upper face 31b, permitting the solidified UV-curing adhesive 4′ to be arranged on the blade 31 more conveniently.

It is noted that when an adhesive injector A is used to inject the UV-curing adhesive 4 to the surface of the air-driving unit 3, the adhesive injector A is able to inject different weights of the UV-curing adhesive 4 to the surface of the air-driving unit 3. In addition, the adhesive injector A has a minimal injection amount which may be 0.04 mg. In other words, the adhesive injector A is able to inject an amount of the UV-curing adhesive 4 larger than or equal to 0.04 mg. Therefore, when the balancing weight is larger than or equal to 0.04 mg, the adhesive injector A is able to inject an amount of the UV-curing adhesive 4, which has the balancing weight, to the weighting location. As such, a processed impeller having provided with the solidified UV-curing adhesive 4′ is formed. Thus, the impeller weight-balancing method according to the disclosure can precisely balance the weight of the impeller, increasing the accuracy in balancing the weight of the impeller.

The impeller weight-balancing method according to the disclosure balances the weight of the impeller by simply injecting the UV-curing adhesive 4 to the surface of the air-driving unit 3 and irradiating the ultraviolet light on the UV-curing adhesive 4 to solidify the UV-curing adhesive 4 as the solidified UV-curing adhesive 4′. Therefore, it is not necessary to form a plurality of holes on the impeller or to proceed the impeller with any other pretreatment for the weight-balancing purpose. Advantageously, the impeller weight-balancing method can be applied to a thin impeller having a reduced height. For example, referring to FIG. 9, the hub 2 and the air-driving unit 3 of the impeller may have a height H smaller than or equal to 6 mm. Although the height H is smaller, the impeller weight-balancing method according to the disclosure can still form the solidified UV-curing adhesive 4′ on the weighting location. This adjusts the center of mass of the impeller back on the shaft 1 and forms a processed impeller (having provided with the solidified UV-curing adhesive 4′). Moreover, since the thin impeller is lightweight, the impeller can be balanced by a smaller volume of the solidified UV-curing adhesive 4′. In this regard, the impeller weight-balancing method according to the disclosure is particularly suitable for the impeller with less than or equal to 6 mm height of the hub 2 and the air-driving unit 3.

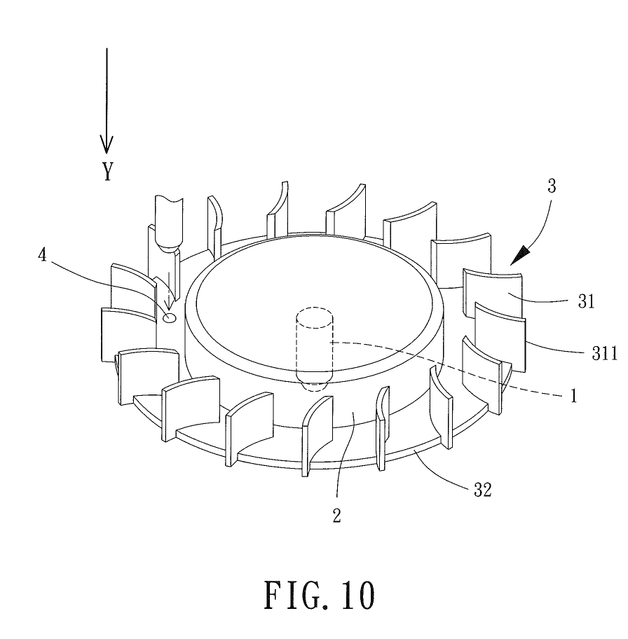

Although the impeller is exemplified as being used in an axial fan in the above embodiment, the impeller can also be used in an advection-type fan in another embodiment. In a further embodiment, the impeller can be used in a centrifugal fan as shown in FIG. 10. In this regard, the air-driving unit 3 may include a bottom plate 32 coupled with the outer periphery of the hub 2, and the blades 31 are coupled with the bottom plate 32. In this example, the solidified UV-curing adhesive 4′ can also couple with one of the blades 31. However, FIG. 10 illustrates that the adhesive injector A can inject the UV-curing adhesive 4 to the bottom plate 32, thus forming the solidified UV-curing adhesive 4′ on the bottom plate 32. As such, the solidified UV-curing adhesive 4′ can be arranged on any part of the air-driving unit 3 (i.e. the blades 31 or the bottom plate 32). Therefore, the location of the solidified UV-curing adhesive 4′ is not limited.

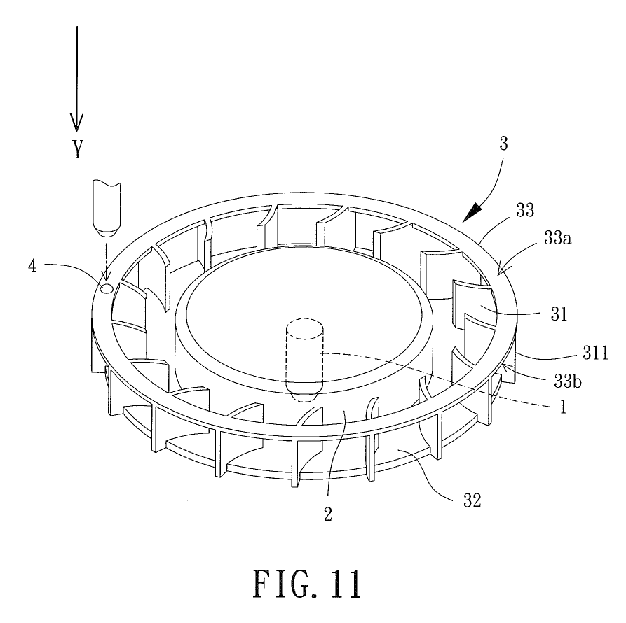

Referring to FIG. 11, the impeller is used in a centrifugal fan in another embodiment of the disclosure, and the air-driving unit 3 further includes a noise-reducing ring 33 coupled with the blades 31. The noise-reducing ring 33 and the bottom plate 32 are coupled with the blades 31 and respectively located at two sides of the blades 31 in an axle direction of the shaft 1. When the impeller is mounted in a fan having an air inlet, the noise-reducing ring 33 can reduce the gap between the blade 31 and the air inlet of the fan, thereby reducing the noise generated during the operation of the impeller. The adhesive injector A can inject the UV-curing adhesive 4 to the noise-reducing ring 33, forming the solidified UV-curing adhesive 4′ on the noise-reducing ring 33. As such, the solidified UV-curing adhesive 4′ can be arranged on any part of the air-driving unit 3 (i.e. the blades 31, the bottom plate 32 or the noise-reducing ring 33). Therefore, the location of the solidified UV-curing adhesive 4′ is not limited. The noise-reducing ring 33 may include an upper face 33a and a lower face 33b opposite to the upper face 33a. The upper face 33a faces away from the bottom plate 32, and the solidified UV-curing adhesive 4′ can be formed on the upper face 33a. In such an arrangement, the upper face 33a of the noise-reducing ring 33 is in an uncovered state, enabling the adhesive injector A to inject the UV-curing adhesive 4 to the upper face 33a. Also, the ultraviolet light of the ultraviolet light source B can easily reach the UV-curing adhesive 4, facilitating the solidification process of the UV-curing adhesive 4. As such, the processing of the impeller is convenient.

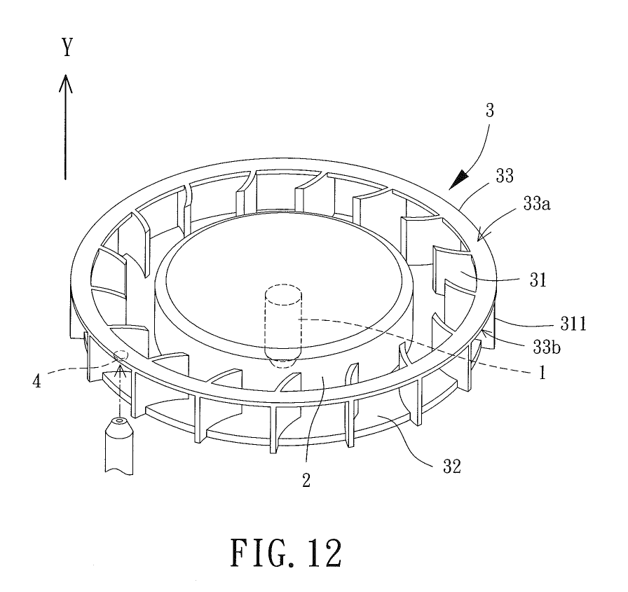

However, as shown in FIG. 12, the solidified UV-curing adhesive 4′ can also be arranged on the lower face 33b of the noise-reducing ring 33. In this arrangement, since the lower face 33b faces the bottom plate 32, the user will not easily notice the solidified UV-curing adhesive 4′ from the air outlet side or the air inlet side of the impeller. Advantageously, the appearance integrity of the processed impeller (having the solidified UV-curing adhesive 4′) can be ensured.

Based on the above structure and method, the processed impeller, the fan having the processed impeller, and the impeller weight-balancing method have the following characteristics.

First, an adhesive injector A is used to inject the UV-curing adhesive 4 having the balancing weight to the weighting location of the impeller, and an ultraviolet light source B is used to irradiate ultraviolet light on the UV-curing adhesive 4 to solidify the UV-curing adhesive 4 as the solidified UV-curing adhesive 4′. As such, the solidified UV-curing adhesive 4′ can be formed on and fixed to the weighting location of the impeller, thereby adjusting the center of mass of the impeller back on the shaft 1. As a result, a processed impeller having the solidified UV-curing adhesive 4′ can be formed. As compared with the conventional impeller weight-balancing method which requires the impeller 9 to form the holes 92 for receiving the weights 91, the processed impeller (having the solidified UV-curing adhesive 4′), the impeller weight-balancing method, and the impeller weight-balancing adjustment system as proposed in various embodiments of the disclosure do not require the impeller to form any hole and do not require the impeller to undergo any other pretreatment. Thus, the impeller can have a lower structural complexity, effectively reducing the difficulty encountered in the production process as well as the manufacturing cost.

Moreover, as compared with the conventional impeller weight-balancing method which requires a longer time for placement or removal of the weights, the processed impeller (having the solidified UV-curing adhesive 4′), the impeller weight-balancing method, and the impeller weight-balancing adjustment system as proposed in various embodiments of the disclosure require a shorter time to form the solidified UV-curing adhesive 4′ on the impeller as it simply takes 3-5 seconds for the UV-curing adhesive 4 to solidify as the solidified UV-curing adhesive 4′ under the irradiation of the ultraviolet light. Thus, the efficiency of the weight-balancing operation is improved. On the other hand, during the rotation of the impeller, the solidified UV-curing adhesive 4′ will not displace under the centrifugal force generated by the rotation of the impeller as the UV-curing adhesive 4 has already solidified as the UV-curing adhesive 4′. This ensures the solidified UV-curing adhesive 4′ to be securely fixed to the weighting location of the impeller. This permits the impeller weight-balancing method of the disclosure to precisely balance the weight of the impeller, and to precisely adjust the center of mass of the processed impeller (having the solidified UV-curing adhesive) back on the shaft 1.

Moreover, the impeller weight-balancing method of the disclosure allows the weighting location to be set on the air-driving unit 3. As such, the solidified UV-curing adhesive 4′ can be arranged on the surface of the air-driving unit 3 of the impeller, thereby reducing the weight required to balance the impeller. The solidified UV-curing adhesive 4′ can be mounted to the blades 31, the bottom plate 32 or the noise-reducing ring 33. Therefore, the location of the solidified UV-curing adhesive 4′ is not limited. Furthermore, since the adhesive injector A is able to inject different weights of the UV-curing adhesive 4, different weights of the solidified UV-curing adhesives 4′ can be formed. As compared with the conventional impeller weight-balancing method which is not able to precisely balance the weight of the impeller 9 due to that the locations of the holes 92 are fixed and that the weight of the weight 91 is also fixed, the processed impeller (having the solidified UV-curing adhesive), the impeller weight-balancing method, and the impeller weight-balancing adjustment system as proposed in various embodiments of the disclosure can provide a precise weight-balancing effect for the impeller.

Moreover, the processed impeller (having the solidified UV-curing adhesive), the impeller weight-balancing method, and the impeller weight-balancing adjustment system as proposed in various embodiments of the disclosure do not need to form the holes on the impeller and do not need to proceed the impeller with any other pretreatment. As such, the impeller weight-balancing method can be applied to a thin impeller having a reduced height, increasing the applicability of the impeller weight-balancing method.

Besides, when the impeller weight-balancing method of the disclosure uses an adhesive injector A to inject the UV-curing adhesive to the surface of the air-driving unit 3, the adhesive injector A has a minimal injection amount which may be 0.04 mg. Based on this, the impeller weight-balancing method according to the embodiment can precisely balance the weight of the impeller when the balancing weight is larger than or equal to 0.04 mg, increasing the accuracy in balancing the weight of the impeller.

In summary, the processed impeller (having the solidified UV-curing adhesive), the impeller weight-balancing method, and the impeller weight-balancing adjustment system as proposed in various embodiments of the disclosure can reduce the production complexity and manufacturing cost of the impeller, and can improve the efficiency of the weight-balancing operation of the impeller, the accuracy in balancing the weight of the impeller, as well as the applicability of the impeller weight-balancing method.

Although the disclosure has been described in detail with reference to its presently preferable embodiments, it will be understood by one of ordinary skill in the art that various modifications can be made without departing from the spirit and the scope of the disclosure, as set forth in the appended claims.

What is claimed is:

1. An impeller having a solidified ultraviolet-curing adhesive, comprising:
a shaft;
a hub coupled with the shaft;
an air-driving unit coupled with the hub; and
a solidified ultraviolet-curing adhesive coupled with a surface of the air-driving unit.

2. The impeller having the solidified ultraviolet-curing adhesive as claimed in claim 1, wherein the solidified ultraviolet-curing adhesive is obtained from an ultraviolet-curing adhesive which is solidified as the solidified ultraviolet-curing adhesive under irradiation of ultraviolet light.

3. The impeller having the solidified ultraviolet-curing adhesive as claimed in claim 1, wherein the air-driving unit comprises a plurality of blades respectively extending in a plurality of radial directions of the shaft, wherein each of the plurality of blades comprises a radially outward edge at a side radially away from the shaft, and wherein the solidified ultraviolet-curing adhesive is relatively adjacent to the radially outward edge and relatively distant to the shaft.

4. The impeller having the solidified ultraviolet-curing adhesive as claimed in claim 1, wherein the air-driving unit comprises a plurality of blades respectively extending in a plurality of radial directions of the shaft, wherein each of the plurality of blades comprises a radially outward edge at a side radially away from the shaft, and wherein the solidified ultraviolet-curing adhesive is arranged on the radially outward edge of one of the plurality of blades.

5. The impeller having the solidified ultraviolet-curing adhesive as claimed in claim 3, wherein the radially outward edges of the plurality of blades form an outer circumference in a circumferential direction perpendicular to the shaft, and wherein a radial distance between the outer circumference and the solidified ultraviolet-curing adhesive is smaller than another radial distance between the solidified ultraviolet-curing adhesive and the shaft.

6. The impeller having the solidified ultraviolet-curing adhesive as claimed in claim 4, wherein the radially outward edges of the plurality of blades form an outer circumference in a circumferential direction perpendicular to the shaft, and wherein a radial distance between the outer circumference and the solidified ultraviolet-curing adhesive is smaller than another radial distance between the solidified ultraviolet-curing adhesive and the shaft.

7. The impeller having the solidified ultraviolet-curing adhesive as claimed in claim 1, wherein the air-driving unit comprises a plurality of blades coupled with an outer periphery of the hub, and wherein the solidified ultraviolet-curing adhesive is coupled with one of the plurality of blades.

8. The impeller having the solidified ultraviolet-curing adhesive as claimed in claim 7, wherein each of the plurality of blades comprises a lower face and an upper face opposite to the lower face, wherein the lower face is located at an air outlet side of the impeller, wherein the upper face is located at an air inlet side of the impeller, and wherein the solidified ultraviolet-curing adhesive is arranged on the lower face of one of the plurality of blades.

9. The impeller having the solidified ultraviolet-curing adhesive as claimed in claim 7, wherein each of the plurality of blades comprises a lower face and an upper face opposite to the lower face, wherein the lower face is located at an air outlet side of the impeller, wherein the upper face is located at an air inlet side of the impeller, and wherein the solidified ultraviolet-curing adhesive is arranged on the upper face of one of the plurality of blades.

10. The impeller having the solidified ultraviolet-curing adhesive as claimed in claim 1, wherein the air-driving unit comprises a bottom plate coupled with an outer periphery of the hub, as well as a plurality of blades coupled with the bottom plate, and wherein the solidified ultraviolet-curing adhesive is coupled with one of the plurality of blades.

11. The impeller having the solidified ultraviolet-curing adhesive as claimed in claim 1, wherein the air-driving unit comprises a bottom plate coupled with an outer periphery of the hub, as well as a plurality of blades coupled with the bottom plate, and wherein the solidified ultraviolet-curing adhesive is coupled with the bottom plate.

12. The impeller having the solidified ultraviolet-curing adhesive as claimed in claim 1, wherein the air-driving unit comprises a plurality of blades, a bottom plate and a noise-reducing ring, wherein the bottom plate is coupled with an outer periphery of the hub, wherein the bottom plate and the noise-reducing ring are coupled with the plurality of blades and respectively located at two sides of the plurality of blades in an axle direction of the shaft, and wherein the solidified ultraviolet-curing adhesive is coupled with the noise-reducing ring.

13. The impeller having the solidified ultraviolet-curing adhesive as claimed in claim 12, wherein the noise-reducing ring comprises an upper face and a lower face opposite to the upper face, wherein the upper face faces away from the bottom plate, wherein the lower face faces the bottom plate, and wherein the solidified ultraviolet-curing adhesive is arranged on the upper face of the noise-reducing ring.

14. The impeller having the solidified ultraviolet-curing adhesive as claimed in claim 12, wherein the noise-reducing ring comprises an upper face and a lower face opposite to the upper face, wherein the upper face faces away from the bottom plate, wherein the lower face faces the bottom plate, and wherein the solidified ultraviolet-curing adhesive is arranged on the lower face of the noise-reducing ring.

15. The impeller having the solidified ultraviolet-curing adhesive as claimed in claim 1, wherein the hub and the air-driving unit have a height in an axle direction of the shaft, and wherein the height is equal to or smaller than 6 mm.

16. A fan comprising:
the impeller as claimed in claim 1; and
a stator to which the shaft is rotatably coupled.

17. The fan as claimed in claim 16, wherein the hub and the air-driving unit have a height in an axle direction of the shaft, and wherein the height is equal to or smaller than 6 mm.

18. An impeller weight-balancing method comprising:
receiving information regarding a weighting location and a balancing weight of an impeller by a compensating module;
injecting an amount of an ultraviolet-curing adhesive, which has the balancing weight, to the weighting location of the impeller by an adhesive injector of the compensating module; and
irradiating ultraviolet light on the ultraviolet-curing adhesive by an ultraviolet light source of a solidification module, wherein the ultraviolet-curing adhesive is solidified and fixed to the weighting location of the impeller under irradiation of the ultraviolet light.

19. The impeller weight-balancing method as claimed in claim 18, wherein the adhesive injector has a minimal injection amount being 0.04 mg.

20. The impeller weight-balancing method as claimed in claim 18, wherein irradiating the ultraviolet light comprises: irradiating the ultraviolet light on the ultraviolet-curing adhesive for 3-5 seconds.

21. The impeller weight-balancing method as claimed in claim 18, wherein the adhesive injector is in a form of a dropper, and injecting the ultraviolet-curing adhesive comprises: dripping the amount of the ultraviolet-curing adhesive to the weighting location of the impeller in an injection direction by the dropper.

22. The impeller weight-balancing method as claimed in claim 18, wherein the adhesive injector is in a form of a nozzle, and injecting the ultraviolet-curing adhesive comprises: spraying the amount of the ultraviolet-curing adhesive to the weighting location of the impeller in an injection direction by the nozzle.

23. The impeller weight-balancing method as claimed in claim 18, further comprising moving the impeller with an aligning member of the compensating module, permitting the weighting location to align with the adhesive injector.

24. The impeller weight-balancing method as claimed in claim 18, further comprising:
determining whether the impeller needs to be balanced according to an offset, as performed by an electrical control module;
if the impeller needs to be balanced, the impeller weight-balancing method further comprises:
setting the weighting location and the balancing weight of the impeller according to the offset, as performed by the electrical control module.

25. The impeller weight-balancing method as claimed in claim 24, further comprising detecting the offset of the impeller with a balance detection module and outputting information regarding the offset of the impeller to the electrical control module prior to the determination of the electrical control module.

26. The impeller weight-balancing method as claimed in claim 25, wherein detecting the offset of the impeller comprises driving the impeller to rotate using a motor of the balance detection module.

27. The impeller weight-balancing method as claimed in claim 26, wherein detecting the offset of the impeller comprises generating information regarding a face run-out and a shaft run-out via an offset detection unit of the balance detection module.

28. The impeller weight-balancing method as claimed in claim 25, wherein detecting the offset of the impeller comprises:
arranging a reference mark on a surface of the impeller;
moving the impeller to the balance detection module by a delivery unit; and
aligning the reference mark with a positioning portion of the balance detection module.

29. The impeller weight-balancing method as claimed in claim 28, wherein, if the electrical control module determines that the impeller needs to be balanced, the impeller weight-balancing method further comprises:
moving the impeller to the compensating module by the delivery unit; and
aligning the reference mark with a positioning portion of the compensating module.

30. An impeller weight-balancing adjustment system comprising:
a balance detection module capable of detecting an offset of an impeller;
an electrical control module coupled with the balance detection module and receiving information regarding the offset of the impeller from the balance detection module, wherein the electrical control module sets a weighting location and a balancing weight of the impeller according to the received information;
a compensating module receiving information regarding the weighting location and the balancing weight and comprising an adhesive injector, wherein the compensating module is capable of injecting an amount of an ultraviolet-curing adhesive, which has the balancing weight, to the weighting location of the impeller via the adhesive injector; and
a solidification module comprising an ultraviolet light source and coupled with the electrical control module or the compensating module, wherein the solidification module is capable of irradiating ultraviolet light on the ultraviolet-curing adhesive with the ultraviolet light source.

31. The impeller weight-balancing adjustment system as claimed in claim 30, wherein the compensating module comprises an aligning member which moves the impeller so that the weighting location of the impeller is aligned with the adhesive injector after the compensating module receives the information regarding the weighting location.

32. The impeller weight-balancing adjustment system as claimed in claim 30, wherein the balance detection module comprises a motor adapted to drive the impeller to rotate, so as to detect the offset of the impeller.

33. The impeller weight-balancing adjustment system as claimed in claim 32, wherein the balance detection module comprises an offset detection unit capable of detecting information regarding a face run-out and a shaft run-out, so as to detect the offset of the impeller.

34. The impeller weight-balancing adjustment system as claimed in claim 30, further comprising a delivery unit coupled with the electrical control module and capable of moving the impeller to the balance detection module or the compensating module.

35. The impeller weight-balancing adjustment system as claimed in claim 34, wherein the delivery unit comprises a visual positioning member capable of locating the impeller.
